(19) United States
(12) Patent Application Publication
(10) Pub. No.: US 2008/0084684 A1
(43) Pub. Date: Apr. 10, 2008

(54) Light emitting table

(76) Inventor: Timothy J. Harney, Granger, IA (US)

Correspondence Address: BRETT J. TROUT, PC, 516 WALNUT, DES MOINES, IA, 50309, US

(21) Appl. No.: 11/544,348

(22) Filed: Oct. 6, 2006

(51) Int. Cl. A61G 13/00

(52) U.S. Cl. 362/33

(57) ABSTRACT

An illuminated table provided with a light transmissive surface laser etched with a design. A plurality of light sources are provided around the perimeter of the light transmissive plate. The light sources are of a sufficient intensity to penetrate the plate a sufficient distance to allow the light emanating from the light sources to be redirected by the etched surface toward the user. The table is preferably provided with a frame to increase the aesthetics by hiding the light source from view.

### BACKGROUND OF THE INVENTION

1. Field of the Invention

The present invention relates in general to a table and, more particularly, to a light transmissive table provided with a light source and an etched surface which glows when illuminated.

2. Description of the Prior Art

It is known in the art to provide light transmissive tables constructed of glass or plastic or the like. It is also known in the art to provide light below such tables to provide illumination up through the surface of the table to a user. One drawback associated with such prior art devices is that the light source illuminates the entirety of the surface. While it is known to specifically direct light sources toward different parts of such tables to highlight those areas, the light sources are typically visible through the table, detracting from the overall aesthetics thereof.

It, therefore, would be desirable to provide a table with a light transmissive surface wherein only certain portions of the table are illuminated to display designs, wording and the like, without the light sources or wiring detracting from the aesthetics. The difficulties encountered in the prior art discussed hereinabove are substantially eliminated by the present invention.

### SUMMARY OF THE INVENTION

In an advantage provided by this invention, a table is provided which illuminates designs provided on the surface of the table.

Advantageously, this invention provides a table which illuminates a desired design on the surface, while reducing visibility of the light source and wiring.

Advantageously, this invention provides a table with an illuminated design on its surface which is able to support a large amount of weight.

Advantageously, this invention provides a table which redirects illumination from a perimeter of the table to a surface design outward toward a user.

Advantageously, this invention provides an illuminated table which is of a low-cost, lightweight manufacture.

Advantageously, this invention provides an illuminated table which provides ease of manufacture and maintenance.

Advantageously, in a preferred example of this invention, a table is provided with a light transmissive plate and at least one leg supporting the plate. A design is provided on the plate, preferably with laser etching, and a light source is directed toward the perimeter of the plate. The light source is of a sufficient intensity to penetrate the plate and be redirected by the etched design toward the user.

### BRIEF DESCRIPTION OF THE DRAWINGS

The present invention will now be described, by way of example, with reference to the accompanying drawings in which:

FIG. 1 illustrates a top perspective view of an illuminated table according to the present invention;

FIG. 2 illustrates a side elevation in cross-section of the light emitting table of FIG. 1;

FIG. 3 illustrates a top perspective view in partial cross-section of an alternative embodiment of the present invention incorporated into a poker table; and

FIG. 4 is a side elevation in partial cross-section of an alternative embodiment of the present invention incorporated into a picture frame.

### DETAILED DESCRIPTION OF THE PREFERRED EMBODIMENT

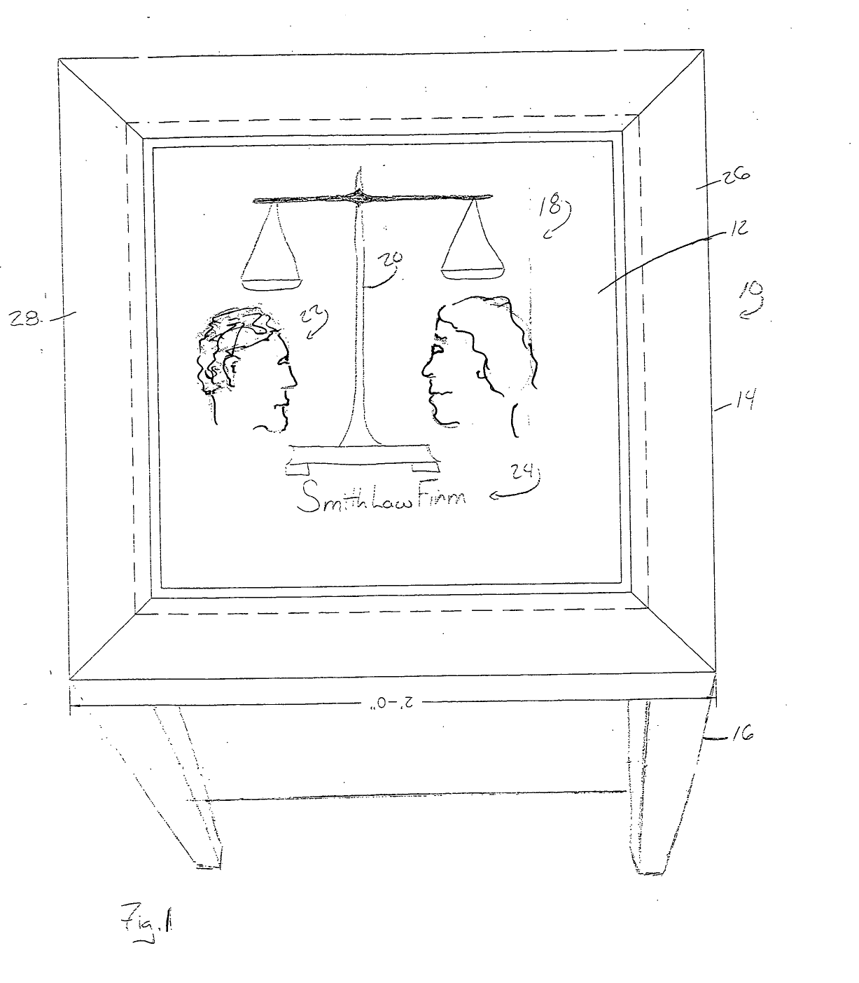

A light emitting table is shown generally as (10) in FIG. 1. The table (10) includes a light transmissive plate (12), surrounded by a frame (14) and supported by four legs (16). While the plate (12) may be constructed of any suitable material, the light transmissive plate is preferably constructed of a substantially transparent material such as plastic or glass. In the preferred embodiment, the plate (12) is a 45 centimeter×45 centimeter square, 1.5 centimeters thick. The plate (12) is also preferably constructed of a material strong enough to support a weight of twenty kilograms over a one hundred centimeter square area which includes the center of the plate (12).

The design (18) includes an object (20), figures (22) and words (24). The design (18), of course, may include any type of design known in the art. The design (18) is preferably cut into the plate (12) using a laser, but may be chemically etched or otherwise provided on the plate (12). In the preferred embodiment, the design (18) is provided on the plate (12) using a Vytek MLT 4496 Monument Lift Table (not shown) or similar laser engraving apparatus.

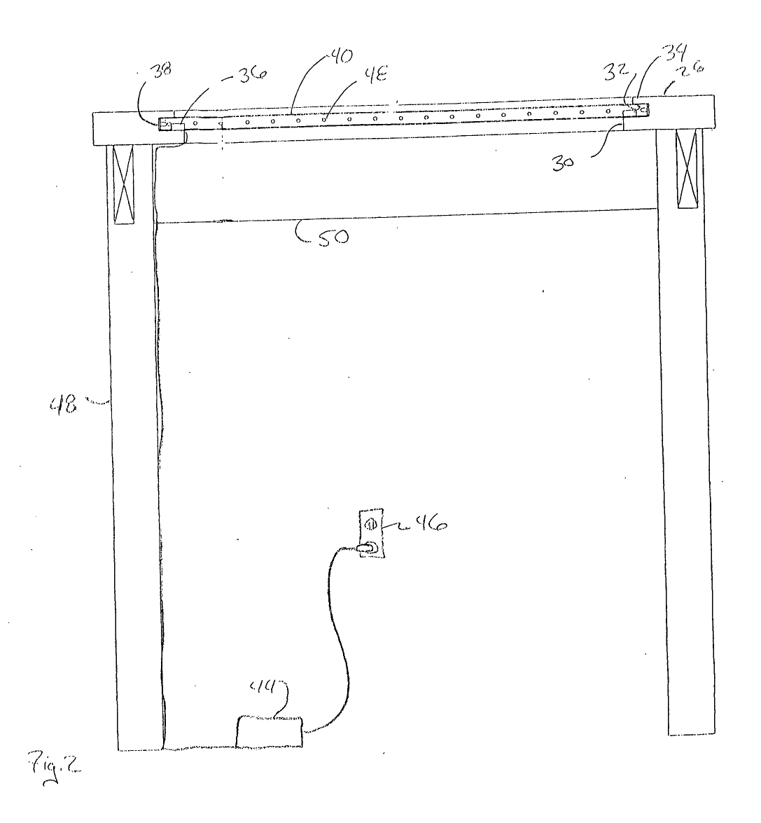

As shown in FIGS. 1 and 2, the plate 12 is secured within a frame (26). As shown in FIG. 2, the frame (26) is constructed of four mitered slats (28) secured to one another by glue (not shown) or similar securement means. The slats (28) are preferably constructed of wood with a bottom (30) 9.39 centimeters wide and 1.27 centimeters high. The bottom (30) is defined by a slot (32) 2.54 centimeters deep and 1.27 centimeters high.

Above the slot (32) is a top (34) 7.94 centimeters wide and 0.64 centimeters high. Provided along the bottom (30) is a rubber gasket (36) 0.64 centimeters high and 1.27 centimeters wide. Provided against each back (38) of each slot (32) is a strip (40) of eighteen twelve volt light emitting diodes (48), such as those known in the art. The strips (40) are wired to a twenty-five watt transformer (44) which converts 120 volt alternating current to twelve volt direct current. The transformer (44) is plugged into a standard 120 volt wall outlet (46).

The plate (12) is provided within the slots (32) of the slats (28) with the tops (34) hiding the strips (40) of light emitting diodes (42) from view. The slats (28) are secured to the four legs (16) and interconnected by four face plates (40). The table can be constructed of any desired dimensions. Preferably, the design (18) is at least five centimeters from the frame (26) to give the impression the design (18) is floating. Although more powerful light emitting diodes (42) or a more transmissive plate (12) may be used to position the design (18) as desired, in the preferred embodiment, no part of the design (18) is more than forty-six centimeters from the nearest light emitting diode (42).

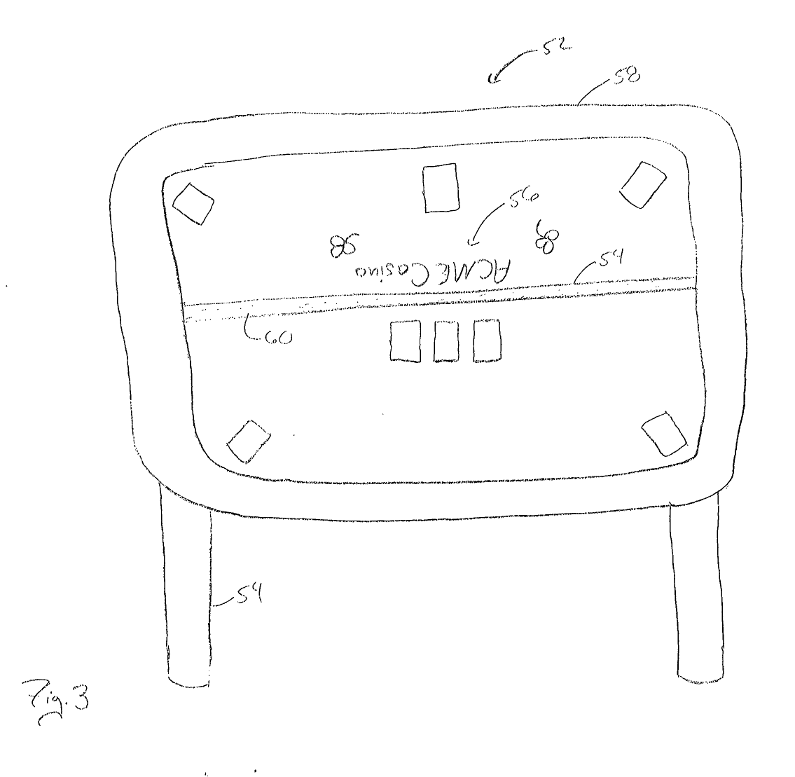

An alternative embodiment of the table is shown generally as (52) in FIG. 3. In this embodiment, the table (52) is provided with longer legs (54) to allow the table (52) to be used as a poker table. The table (52) is provided with a center rail (54) to allow designs (56) to be positioned more than forty-six centimeters from the outer padded frame (58). The center rail (54) is provided with light emitting diodes (60) to illuminate the designs (56).

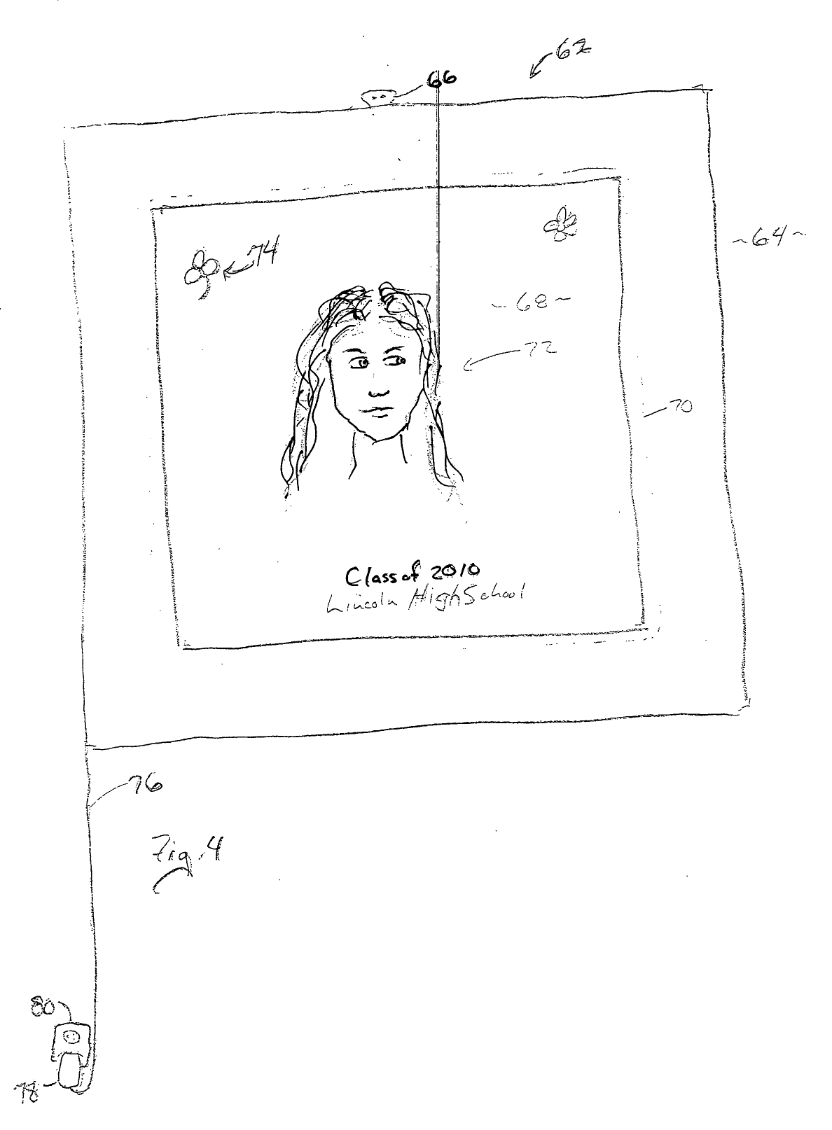

Another alternative embodiment frame of the present invention is shown generally as (62) in FIG. 4. The frame (62) is secured to a wall (64) by a picture hanger (66) or similar securement means. A light transmissive plate (68) is secured to the frame (62) and light emitting diodes (70) are provided around the plate (68). A photograph (72) is secured behind the plate (68) and a plurality of designs (74) are etched into the plate to highlight and accent the photograph (72) The light emitting diodes (70) are connected by a wire (76) to a transformer (78) plugged into an outlet (80).

Although the invention has been described with respect to a preferred embodiment thereof, it is to be understood that it is not to be so limited since changes and modifications can be made therein which are within the full, intended scope of this invention as defined by the appended claims.

What is claimed is:

1. A table comprising:
(a) a light transmissive plate defining a perimeter;
(b) a design provided on said plate, wherein said design is of a construction which redirects at least some light encountering said design from a direction parallel to said plate to a direction non-parallel to said plate;
(c) a light source directed toward said perimeter of said plate, wherein said light is of a sufficient intensity to penetrate said plate sufficiently to be redirected by said design in a direction non-parallel to said plate; and
(d) a leg supporting said plate.

2. The table of claim 1, wherein said design is located at least five centimeters from said perimeter.

3. The table of claim 1, wherein at least a portion of said design is located at least twenty centimeters from said perimeter.

4. The table of claim 1, wherein said plate is of a strength sufficient to support a weight of at least ten kilograms positioned at the center of said plate.

5. The table of claim 1, further comprising a frame provided around said plate.

6. The table of claim 5, wherein said frame covers the entirety of said perimeter of said plate.

7. The table of claim 1, wherein said plate is glass.

8. The table of claim 7, wherein said design is etched into said plate.

9. The table of claim 1, wherein said design is etched into said plate.

10. The table of claim 1, wherein said plate is at least four hundred square centimeters in area.

11. The table of claim 1, wherein said light source is a light emitting diode.

12. A frame assembly comprising:
(a) a light transmissive plate defining a perimeter;
(b) a design provided on said plate, wherein said design is of a construction which redirects at least some light encountering said design from a direction parallel to said plate to a direction non-parallel to said plate;
(c) a light source directed toward said perimeter of said plate, wherein said light is of a sufficient intensity to penetrate said plate sufficiently to be redirected by said design in a direction non-parallel to said plate; and
(d) a frame provided around said perimeter.

13. The frame assembly of claim 12, wherein said design is located at least five centimeters from said perimeter.

14. The frame assembly of claim 12, wherein at least a portion of said design is located at least twenty centimeters from said perimeter.

15. The frame assembly of claim 12, wherein said plate is glass.

16. The frame assembly of claim 15, wherein said design is etched into said plate.

17. The frame assembly of claim 12, wherein said light source is a light emitting diode.

18. A table comprising:
(a) a light transmissive plate defining a perimeter;
(b) a light disruptive design etched into said plate;
(c) a plurality of light sources provided along at least a portion of said perimeter;
(d) wherein said light source is of a sufficient strength to penetrate said plate sufficiently to illuminate said design; and
(e) a leg supporting said plate.

19. The table of claim 18, wherein portions of said plate not provided with said design are illuminated at less than one tenth the illumination of at least a portion of said design.

20. The table of claim 18, wherein said light source is a plurality of light emitting diodes.
